(19) United States
(12) Patent Application Publication
(10) Pub. No.: US 2006/0033041 A1
(43) Pub. Date: Feb. 16, 2006

(54) Ion implantation monitor system and method thereof

(75) Inventors: Shian-Jyh Lin, Chiayi Hsien (TW); Yuan-Song Tai, Taoyuan County (TW)

Correspondence Address: QUINTERO LAW OFFICE, 1617 BROADWAY, 3RD FLOOR, SANTA MONICA, CA, 90404, US

(73) Assignee: NANYA TECHNOLOGY CORPORATION, TAOYUAN (TW)

(21) Appl. No.: 11/203,002

(22) Filed: Aug. 11, 2005

(30) Foreign Application Priority Data
Aug. 12, 2004 (TW) TW93124173

(51) Int. Cl. B01D 59/44

(52) U.S. Cl. 250/489

(57) ABSTRACT

An ion beam energy monitor system and method thereof. A physical field generator generates a physical field in a direction not parallel to an ion beam, refracting the ion beam, and a receiving device located on the path of the refracted ion beam receives the ion beam and calculates the energy thereof according to a collision distribution of ions of the ion beam. The output energy of the ion beam is thus being well adjusted.

### BACKGROUND

The present invention relates to an energy monitor system, and more particularly, to an energy monitor system for electric particles and method thereof.

In semiconductor fabrication, dopants are often applied into a semiconductor wafer to control a number of electric carriers and form a conductive area, using doping methods such as liquid deposition, thermal diffusion, or chemical evaporation. Moreover, ion implantation is used more widely due to high precision.

During ion implantation, dopant atoms or molecules are ionized in advance, such as P⁺ or BF₂⁺. Ions are accelerated by an accelerator to acquire a certain kinetic energy and then implanted into a semiconductor wafer. The depth distribution of the implanted ions is obtained by precisely controlling the output energy of an ion implantation device. Also, the concentration of the implanted dopants is controlled by implantation time and output energy. Furthermore, ion implantation provides uniform distribution of dopants and can precise implanting into desired areas with proper masks.

Typically, an ion beam comprises a plurality of ions of the same type. The output energy of ions of the ion beam almost follows a normal distribution. In general the output energy of an ion implantation process is typically controlled from 10 to 200 KeV or even higher at mega eV (Mev) level.

Depth distribution of the implanted ions in the formed doped region varies with output energy of the ion implantation device. Due to the inaccuracy, the real output energy, equal to the kinetic energy of the ions, is different from the desired output energy of the ion implantation device. Thus, it is necessary to calibrate the ion implantation device for improving the precision in ion implantation process.

Ion implantation device calibration is typically performed by destructive procedures, such as implanting ions with a predetermined output energy into a test target, such as a silicon wafer. Thereafter, the test target is cut to be test samples and then using an electronic microscope, for example Secondary Ion Mass Spectroscopy (SIMS), to check the ion implantation results in the test samples. It is a complex and time-consuming procedure. Consequently, the calibration cannot be performed frequently, and it can be only performed for some specific output energy levels. Therefore, the accuracy of the ion implantation device calibration is further limited. In general, inaccuracy remains at about 200 eV or even higher after conventional calibration.

As semiconductor device dimensions reduce and integration increases, required doped regions move closer and closer to the surface of the semiconductor wafer, as well as the output energy is reducing accordingly, such as 2 KeV. Despite the implantation energy decreasing significantly, inaccuracy of output energy from implantation device remains about 200 eV. Therefore, in order to meet the demand of more accuracy controlled implantation process, it is needed to provide a rapid and accurate energy monitor system.

### SUMMARY

Embodiments of the invention provide an ion beam energy monitor device for modifying energy of an ion beam generated by an ion beam generator. The system comprises a physical field generator and a receiving device. The physical field generator generates a physical field on a moving path of the ion beam to refract the moving path of the ion beam. The receiving device receives the refracted ion beam and calculates an energy profile of the ion beam. Moreover, the ion beam generator modifies the energy of the ion beam generated by the ion beam generator according to the energy profile.

Embodiments of the invention further provide an energy monitor system. The system comprises an electric particle generator and an energy monitor device. The electric particle generator generates a plurality of electric particles and outputs the electric particles with an output-energy toward a first direction. The energy monitor device comprises a physical field generator and a receiving device. The physical field generator generates a physical field in a second direction on a path of the electric particles to refract the electric particles toward a third direction. The receiving device receives the refracted electric particles and detecting a collision distribution of the electric particles. The energy monitor device calculates an energy profile of the electric particles according to the detected collision distribution of the electric particles. The electric particle generator modifies the output energy according to the energy profile of the electric particles.

Also present invention provides a method of monitoring an output-energy of an ion beam. The method comprises, providing an ion beam generator generating an ion beam with the output-energy, applying a physical field on a path of the ion beam, refracting the moving path of the ion beam, receiving the refracted ion beam by a receiving device, calculating an energy profile of the ion beam according to a collision distribution of ions of the ion beam, and modifying the output-energy of the ion beam according to the energy profile of the ion beam.

A detailed description is given in the following embodiments with reference to the accompanying drawings.

### DESCRIPTION OF THE DRAWINGS

Embodiments of the invention can be more fully understood by reading the subsequent detailed description and examples with references made to the accompanying drawings, wherein:

FIG. 1 is a schematic diagram of an embodiment of an energy monitor system;

FIG. 2 is a schematic diagram of an embodiment of a physical field generator; and

FIG. 3 is a schematic diagram of an embodiment of a receiving device.

### DETAILED DESCRIPTION

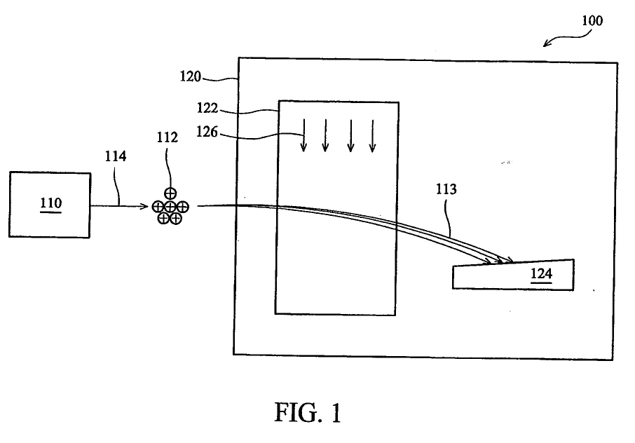

FIG. 1 is a schematic diagram of an embodiment of an energy monitor system 100. As shown, the energy monitor system 100 comprises an electric particle generator 110 generating an electric particle beam 112 and an energy monitor device 120 monitoring an energy profile of the electric particle beam 112 and adjusting output energy of the electric particle generator 110 accordingly. After the electric particle beam 112 is generated, the electric particle generator 110 outputs the electric particle beam 112 with various output kinetic energy in a first direction 114. The kinetic energy profile of electric particles of the electric particle beam 112 follows a normal distribution with average kinetic energy corresponding to a setting value of the output energy of the electric particle generator 110. The energy monitor device 120 comprises a physical field generator 122 generating a uniform physical field on a path of the electric particle beam 112 with a known intensity, applying an acting force in a second direction 126 to the electric particle beam 112, not parallel to the first direction 114, such that the electric particle beam 112 is refracted toward a third direction 113. The energy monitor device 120 further comprises a receiving device 124 disposed on the refracted moving path of the electric particle beam 112, receiving the electric particle beam 112. The receiving device further detects and records a collision distribution of electric particles. Since the intensity of the physical field is already known, velocity of an electric particle can be calculated according to its colliding location on the receiving device. Thus, a kinetic energy profile of the electric particle beam is obtained and output energy of the electric particle generator 110 calibrated accordingly.

While the ion implantation energy monitor system applied to semiconductor process is illustrated, the invention is not limited thereto, but can be further applied to other system types, such as medical applications and others.

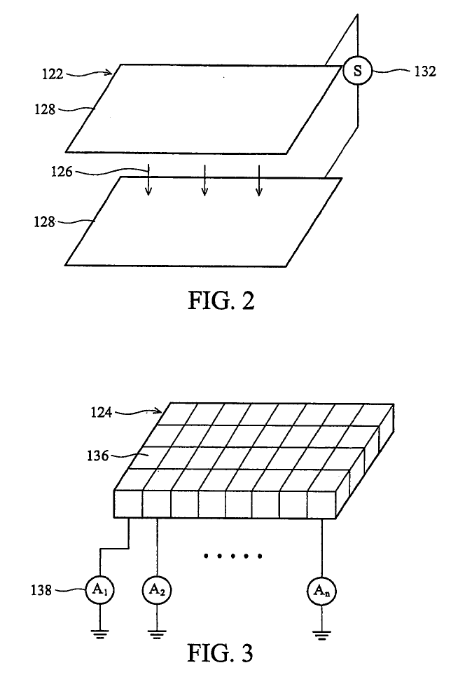

FIG. 2 is a schematic diagram of an embodiment of a physical field generator 122. Physical field generator 122 comprises two parallel electric plates 128 and a direct current power supply 132 electrically connected thereto. An electric field is generated between the two electric plates 128 at a known intensity in a second direction 126. When positive electric particles or cations pass through the electric field, an electric force in the second direction 126 influences the positive electric particles, refracting them toward the third direction 113 gradually. Negative particles or anions respond in the same manner except opposite the direction of the electric field between the two electric plates 128. Those skilled in the art can readily modify aforementioned devices for negative ions, thus detail description is omitted.

Note that although an electric field generator is illustrated here, the invention is not limited thereto, but can be embodied in other variations. For example, two magnetic coils can be disposed on the moving path of the electric particle beam 112 to generate a uniform magnetic field and an acting force thereon to refract the electric particles 112 from its original direction (first direction 126) to the third direction 113 gradually.

FIG. 3 is a schematic diagram of an embodiment of a receiving device. As shown, the receiving device comprises a plurality of Faraday devices uniformly arranged on a surface thereof. Each Faraday device comprises a conductive receiving surface 136 and an ampere meter 138 with one end electrically connected to a corresponding receiving surface 136 and the other to ground. As before, the receiving device 124 is disposed in the path of the deviated ion beams to receive the electric particles. Since the various kinetic energy of ions in the electric particle beam 112 follow normal distribution, ions will not collided with the receiving device 124 at the same position. But, the collision locations distributed across a plurality of Faraday devices within a set range. Electric particles reaching a receiving surface 136 of a Faraday device, a positive charge or positive charges move from the receiving surface 136 to ground through the ampere meter 138 and generate a current. Thus, according to the measured current value on each ampere meter 138, such as A1, A2, . . . , or An as illustrated in FIG. 3, the quantities of electric particles colliding with the corresponding faraday devices are counted, such the collision distribution of the particles of the electric particle beam 112 is obtained. Electron multipliers (EMs) or ion image detectors can also be employed to detect impact distribution of the electric particle beam 112.

Further provided is an embodiment of a method of monitoring energy of electric particles. While an implantation device is illustrated in this disclosure, the method is not limited thereto, but can be applied to various applications.

An ion beam is output in a first direction with predetermined output energy by an ion implantation device. A physical field in a second direction 126 is applied to the ion beam by a physical field generator 122 disposed on the moving path of the ion beam, the second direction 126 not parallel to the first direction 114, such that the ion beam is refracted toward the third direction 113 gradually.

Receiving device 124 receives the ion beam. As previously mentioned, the receiving device 124 can detect the colliding locations of all ions and record the collision distribution of the ions. Since the physical field intensity and the composition of each ion are both already known, thus the initial velocity and the kinetic energy when the ions leave the electric particle generator 110 can be figured out, i.e. the energy profile of the electric particle beam 112 is obtained.

Also, even an ion beam comprises an ion only, the kinetic energy of the ion can be calculated according to the method mentioned above of present invention. Therefore, the real output energy of the electric particle generator 110, equal to the real implanting energy, is obtained.

Then, the electric particle generator 110 modifies the output energy of the electric particle beam 112 according to the obtained energy profile of the electric particle beam 112.

The present invention provides a non-destructive energy monitor system, method to monitor and calibrate various output energy of the electric particle beam rapidly and accurately. The output energy of an ion beam generated by ion beam generator is more stable. Therefore, the accuracy of ion implantation can be well controlled, and the reliability of ion implantation can be further improved.

While the invention has been described by way of example and in terms of preferred embodiment, it is to be understood that the invention is not limited thereto.

What is claimed is:

1. An ion beam energy monitor device for monitoring energy of an ion beam generated by an ion beam generator, comprising:
a physical field generator for generating a physical field on a moving path of the ion beam to refract the moving path of the ion beam; and
a receiving device for receiving the refracted ion beam and calculating an energy profile of the ion beam;
wherein the ion beam generator modifies the energy of the ion beam generated by the ion beam generator according to the energy profile.

2. The ion beam energy monitor device as claimed in claim 1 wherein the physical field generator comprises two electrode plates and an adjustable direct current power provided thereto for generating an electric field therebetween.

3. The ion beam energy monitor device as claimed in claim 1 wherein the physical field generator comprises two magnetic coils for generating a magnetic field therebetween.

4. The ion beam energy monitor device as claimed in claim 1 wherein the receiving device comprises an electron multiplier (EM), Faraday device, or ion image detector.

5. The ion beam energy monitor device as claimed in claim 1, wherein the energy profile is calculated according to a collision distribution of ions of the ion beam.

6. An energy monitor system comprising:
an electric particle generator generating a plurality of electric particles and output the electric particles with an output energy toward a first direction; and
an energy monitor device monitoring the output energy of the electric particles, comprising:
a physical field generator generating a physical field in a second direction on a path of the electric particles to refract the electric particles toward a third direction; and
a receiving device receiving the refracted electric particles and detecting a collision distribution of the electric particles;
wherein the energy monitor device calculates an energy profile of the electric particles according to the detected collision distribution of the electric particles, and the electric particle generator modifies the output energy according to the energy profile of the electric particles.

7. The energy monitor system as claimed in claim 6 wherein the physical field generator comprises two electrode plates and an adjustable direct current power provided thereto for generating an electric field therebetween.

8. The energy monitor system as claimed in claim 6 wherein the physical field generator comprises two magnetic coils for generating a magnetic field therebetween.

9. The energy monitor system as claimed in claim 6 wherein the receiving device comprises an electron multiplier (EM), Faraday device, or ion image detector.

10. A method of monitoring an output-energy of an ion beam comprising:
providing an ion beam generator generating an ion beam with the output-energy;
applying a physical field on a path of the ion beam, to refract the moving path of the ion beam;
receiving the refracted ion beam by a receiving device;
calculating an energy profile of the ion beam according to a collision distribution of ions of the ion beam; and
modifying the output-energy of the ion beam according to the energy profile of the ion beam.

11. The method of monitoring an output-energy of an ion beam as claimed in claim 10 wherein applying the physical field comprises:
providing two electrode plates; and
providing an adjustable direct current power electrically connected to the two electrode plates for generating an electric field between the two electrode plates.

12. The method of monitoring an output-energy of an ion beam as claimed in claim 10 wherein the physical field is a magnetic field formed between two magnetic coils.

13. The method of monitoring an output-energy of an ion beam as claimed in claim 10 wherein the receiving device comprises an electron multiplier (EM), Faraday device, or ion image detector.
